(19) United States
(12) Patent Application Publication
(10) Pub. No.: US 2003/0076257 A1
(43) Pub. Date: Apr. 24, 2003

(54) Antenna array monitor and monitoring method

(76) Inventor: Neus Padros, Santa Rosa, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/050,424

(22) Filed: Oct. 24, 2001

(51) Int. Cl. G01S 7/40; H01Q 3/22

(52) U.S. Cl. 342/368; 342/173

(57) ABSTRACT

An antenna array monitor includes a probe coupled to a first antenna and one or more second antennas within an antenna array of a tower. The probe acquires transmission parameters between the first antenna and the one or more second antennas in the array. The acquired transmission parameters include baseline transmission parameters between the first antenna and the one or more second antennas and measured transmission parameters between the first antenna and the one or more second antennas. A communication channel optionally coupling the probe to a remote site enables an operating condition of the antenna array based on a comparison of the measured transmission parameters and the baseline transmission parameters to be conveyed to a remote site.

### BACKGROUND OF THE INVENTION

Antenna arrays are coupled to base stations within many types of wireless communication systems. Typically, an antenna array uses multiple array elements, or antennas, to achieve a designated field radiation pattern. Performance of a wireless communication system depends on the operating condition of the antenna arrays within the system. For example, changes in physical alignment of the array elements, corrosion, or physical damage to the array elements can cause signal dropout, poor signal-to-noise ratio, or other types of performance problems in the communication system in which the antenna arrays are included. Therefore, monitoring the operating condition of antenna arrays is critical to monitoring the performance of wireless communication systems.

Known antenna array monitoring relies on field detectors at locations distant from the antenna array that measure signal levels at various points in the field radiation pattern of the antenna array. Because the signal levels measured by the field detectors are sensitive to both environmental conditions and physical obstacles in the signal path between the antenna array and the field detector, it is difficult to determine whether variations in signal levels that are measured by the field detector are the result of changes in the environmental or physical conditions of the signal path, or whether the variations are the result of changes in the operating condition of the antenna array. As a result of this drawback, this type of antenna array monitoring is not effective for detecting and isolating changes in the operating conditions of the antenna array that can influence the performance of the wireless communication system within which the antenna array is included. Accordingly, there is a need for antenna array monitor that does not rely on measurements of signal levels at locations that are distant from the antenna array in order to verify the operating condition of the antenna array.

### SUMMARY OF THE INVENTION

This need is met by an antenna array monitor and a monitoring method for an antenna array, constructed according to the embodiments of the present invention. The antenna array monitor, constructed according to a first embodiment of the present invention, includes a probe coupled to a first antenna and one or more second antennas within the antenna array of a tower. The probe acquires transmission parameters between a first antenna and the one or more second antennas in the array. The acquired transmission parameters include baseline transmission parameters between the first antenna and the one or more second antennas and measured transmission parameters between the first antenna and the one or more second antennas. A communication channel couples the probe to a remote site, enabling operating conditions of the antenna array, based on a comparison of the measured transmission parameters and the baseline transmission parameters, to be conveyed. A monitoring method for the antenna array is constructed according to an alternative embodiment of the present invention.

### BRIEF DESCRIPTION OF THE DRAWINGS

FIG. 1 shows an example of an antenna array for use with the antenna array monitor and the monitoring method for the antenna array, constructed according to the embodiments of the present invention.

FIG. 2 shows an antenna array monitor constructed according to the embodiments of the present invention.

FIG. 3 shows an example of a field radiation pattern of an array element within the antenna array shown in FIG. 1.

### DETAILED DESCRIPTION OF THE EMBODIMENTS

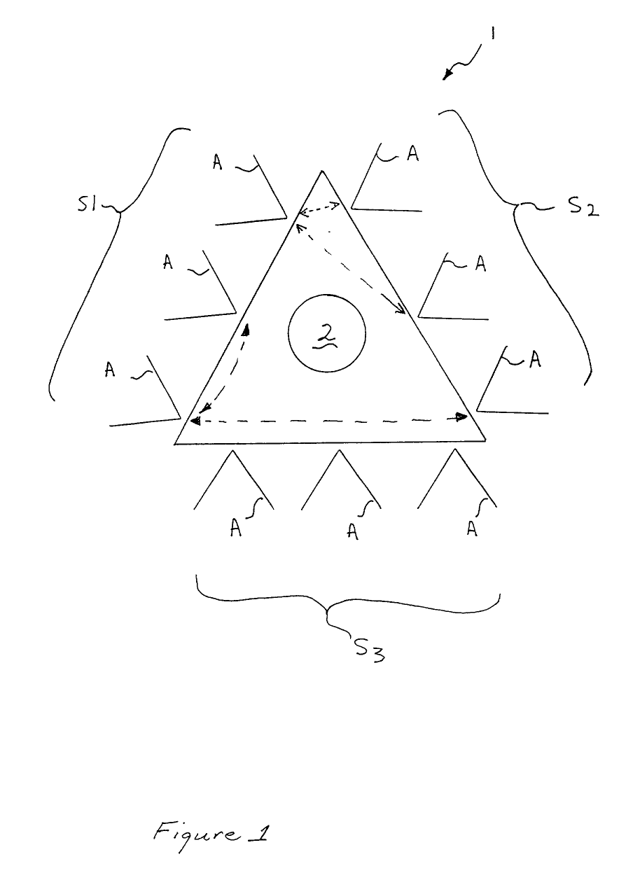

FIG. 1 shows an example of an antenna array 1 for use with an antenna array monitor constructed according to the embodiments of the present invention. The antenna array 1 is mounted on a tower 2, which is typically a manufactured structure or natural physical structure that is adapted to receive the antenna array 1. The antenna array 1 includes one or more sectors. In this example, the antenna array 1 is shown having three sectors S₁-S₃.

Each of the sectors S₁-S₃ includes one or more array elements A, or antennas A. The sectors S₁-S₃ provide transmission of communication signals (not shown) via the antennas A within the antenna array 1, reception of communication signals via the antennas A within the antenna array 1, or transmission and reception of communication signals via the antennas A within the antenna array 1. Each of the antennas A within the antenna array 1 is of a similar type or different type, depending on the function of the antenna A within the antenna array 1 and depending on the type of polarization of the communication signals transmitted or received by the antenna array 1.

During normal operation of the antenna array 1 in a wireless communication system, communication signals within a series of operating channels are received from, or directed to, other towers or distant locations within a field radiation pattern of the antenna array 1. The communication signals are generally not used to establish an operating channel between the antennas A within the antenna array 1 of a single tower 2 during normal operation of the wireless communication system. However, to monitor operating conditions of the antenna array 1 according to the embodiments of the present invention, transmission parameters that indicate cross-coupling between various ones of the array elements A within the antenna array 1 of a tower 2 are acquired. Examples of the cross-coupling are indicated by arrows in FIG. 1.

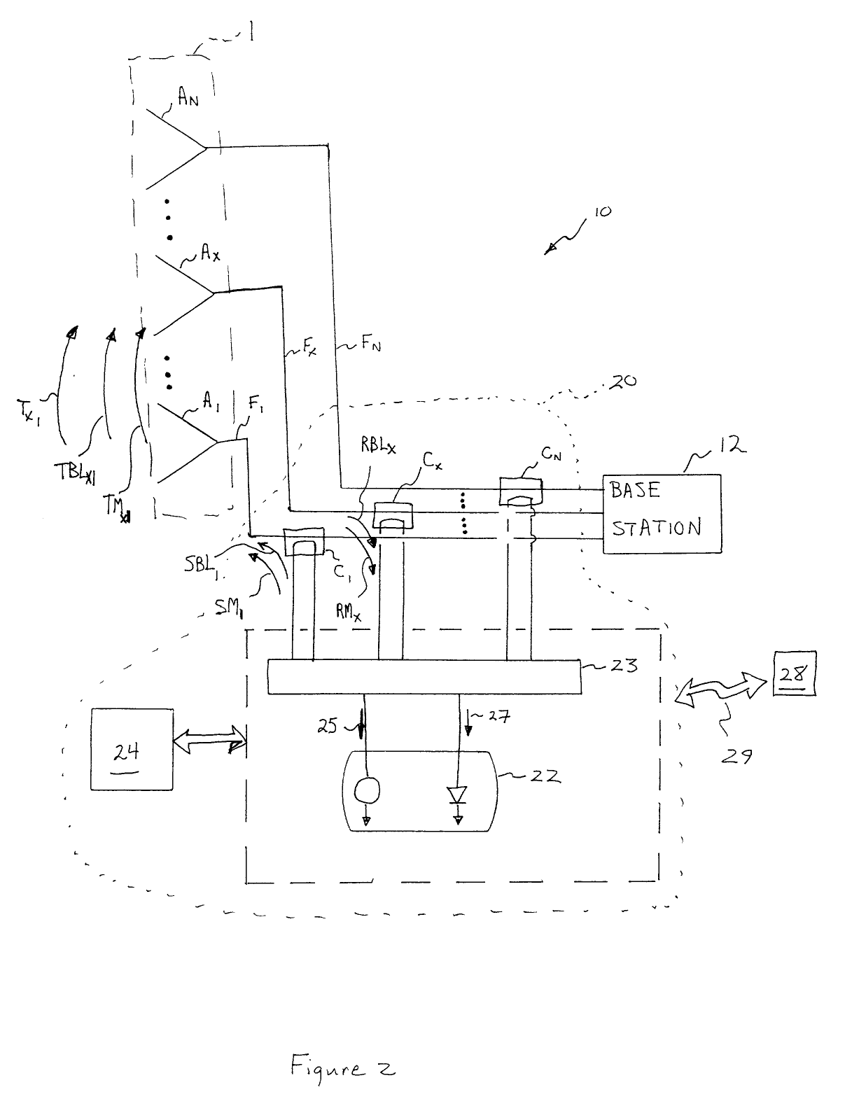

FIG. 2 shows the antenna array monitor 10 constructed according to the embodiments of the present invention. Each of the antennas A in the antenna array 1, as shown in FIG. 1, is indexed in FIG. 2 as an array element or antenna A_{X}, within a series of array elements A₁-A_{N} or antennas A₁-A_{N}, making up the antenna array 1. Each of the array elements A_{X}, or antennas A_{X} has a corresponding feed line F_{X}, within a corresponding series of feed lines F₁-F_{N}, that couples each of the antennas A₁-A_{N} to a base station 12 or other type of terminal. The antenna array monitor 10 includes a probe 20 coupled to two or more of the feed lines F₁-F_{N} through corresponding signal couplers C₁-C_{N}.

The probe 20 includes a vector network analyzer or other stimulus/response system 22 capable of acquiring transmission parameters T_{X1} between a first antenna A₁ in the antenna array 1 and one or more additional antennas A_{X} within the antenna array 1. Although the sectors S₁-S₃ are not indicated in FIG. 2, the first antenna A₁ and the one or more additional antennas A_{X} between which the transmission parameters T_{X1} are acquired are either within the same sector or within different sectors of the antenna array 1.

The transmission parameters T_{X1} include baseline transmission parameters TBL_{X1} and measured transmission parameters TM_{X1}. The probe 20 establishes the baseline transmission parameters TBL_{X1} by coupling a reference stimulus signal SBL₁ at one or more frequencies within the series of operating channels to the first antenna A₁ and measuring a reference response signal RBL_{X} to the reference stimulus signal SBL₁ coupled from the one or more additional antennas A_{X} in the antenna array 1. Alternatively, the baseline transmission parameters TBL_{X1} are established according to mathematical models or empirical data representing the cross-coupling or the transmission parameters TBL_{X1} between the first antenna A₁ and the one or more additional antennas A_{X}. Establishing the baseline transmission parameters TBL_{X1} using the reference stimulus signal SBL₁ and the measured response signal RBL_{X} alleviates the task of modeling a near-field radiation pattern of the antennas A₁-A_{N} that results from the antennas A₁-A_{N} being physically proximate to each other.

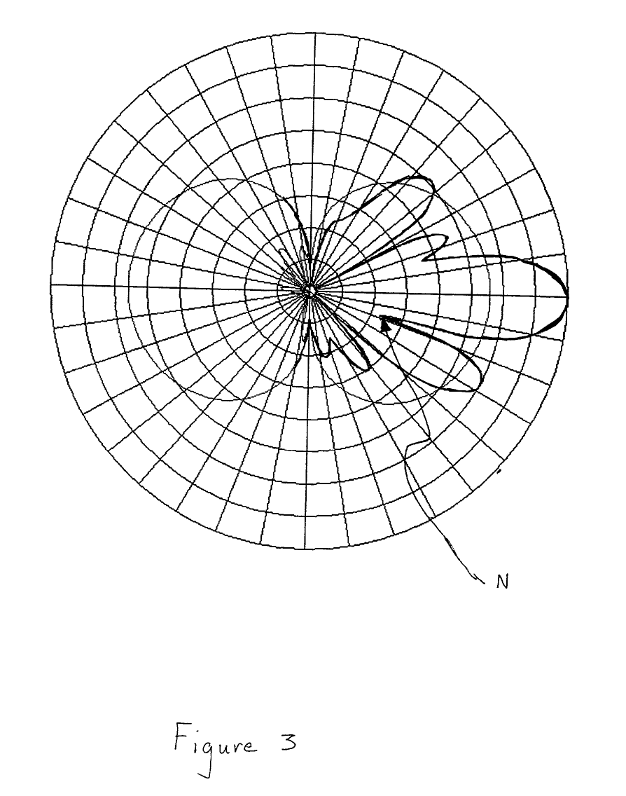

The probe 20 establishes the measured transmission parameters TM_{X1} by coupling a measurement stimulus signal SM₁ at the one or more frequencies within designated channel within the series of operating channels to the first antenna A₁ and measuring a measurement response signal RM_{X} to the measurement stimulus signal SM₁ from the one or more additional antennas A_{X}. To avoid interference or interruption in the operation of the communication system within which the antenna array 1 is included, the designated channel is conveniently chosen to be an inactive channel within the series of operating channels. When the one or more frequencies are chosen for alignment with a null N in the field radiation pattern of a first antenna A₁ or the one or more second antennas A_{X} within the antenna array 1 as shown in FIG. 3, a slight change in the azimuthal alignment of the antennas produces a large change in the measured transmission parameters TM_{X1} between the first antenna A₁ and one or more additional antennas A_{X} that are aligned with the null N. Thus, the one or more frequencies are optionally chosen for maximum sensitivity to changes in operating conditions of the antenna array 1.

Typically, the stimulus/response system 22 included in the probe 20 shown in FIG. 2 acquires transmission parameters T_{X1} that are scattering parameters, or S-parameters. However, the baseline transmission parameters TBL_{X1} alternatively include a ratio of the reference stimulus signal SBL₁ and the reference response signal RBL_{X}, and the measured transmission parameters TM_{X1} alternatively include a ratio of the measurement stimulus signal SM₁ and the measurement response signal RM_{X}. Other types of transmission parameters T_{X1} suitable for characterizing signal transmission between the first antenna A₁ and the one or more additional antennas A_{X} are alternatively used.

The baseline and measurement transmission parameters may include a matrix of transmission parameters indicating the cross-coupling between designated first antennas A₁ and designated multiple additional antennas A_{X} within the antenna array 1. The matrix of baseline transmission parameters TBL_{X1} represents a reference or baseline operating condition of the antenna array 1, while the matrix of measured transmission parameters TM_{X1} represents actual operating condition of the antenna array 1 at the time the matrix of the measured transmission parameters TM_{X1} is acquired.

The probe 20 includes a computer or other type of processor 24 having capability to compare the acquired measured transmission parameters TM_{X1} to the baseline transmission parameters TBL_{X1}. Based on this comparison, the operating status or condition of the antenna array 1 is established.

Deviations of the measured transmission parameters TM_{X1} from the baseline transmission parameters TBL_{X1}, that exceed designated thresholds, are mapped to a set of operating condition of the antenna array 1. For example, decreases in a measured transmission parameter TM₂₁ between a first antenna and one or more second antennas within the antenna array 1, relative to a baseline transmission parameter TBL₂₁, that coincide with increases in the measured transmission parameters TM₃₁ between the first antenna and one or more third antennas within the antenna array 1, relative to a baseline transmission parameter TBL₃₁, in excess of a first threshold, are optionally mapped to an azimuthal rotation of the first antenna toward the one or more third antennas within the antenna array 1. As another example, an increase in the measured transmission parameters TM_{X1}, relative to a baseline transmission parameter TBL_{X1}, between a first antenna A₁ and one or more second antennas A_{X} in a rear lobe of the first antenna of the antenna array 1, that exceeds a second threshold, is optionally mapped to corrosion of a rear reflector of the first antenna A₁. Other thresholds are additionally designated, either empirically or through mathematical modeling, as a result of correlating the acquired transmission parameters T_{X1} to observed operating conditions of the antenna array 1. The mapping of the thresholds to operating conditions of the antenna array 1 is pre-established or is based on data accumulated from monitoring the antenna array 1 over time.

The probe 20 optionally acquires reflection parameters, such as reflection S-parameters or time domain reflection characteristics of designated ones of the antennas A₁-A_{N} within the antenna array 1, to further discern the operating condition of the designated antennas within the antenna array 1 and the feed lines of the antennas, and to establish distance-to-fault characteristics.

A switch matrix 23 within the stimulus/response system 22 of the probe 20 is used to couple stimulus signals 25 provided by the stimulus/response system 22 to the appropriate ones of the feed lines F₁-F_{N} through signal couplers C₁-C_{N} and to couple response signals 27 from the appropriate ones of the feed lines F₁-F_{N} through signal couplers C₁-C_{N} to the stimulus/response system 22, so that designated transmission parameters and reflection parameters are acquired by the probe 20.

A hard-wired link, wireless link, or other type of communication channel 29 is optionally included to couple the probe 20 to a remote site 28. The communication channel 29 enables the operating condition or status of the antenna array 1 to be conveyed to the remote site 28. The hard-wired link, being an internet link, optical link or other hard-wired transmission path, and the wireless link, being a cellular phone link, radio link or other open transmission path, can be use independently, or in combination. As an example, when the hard-wired link and the wireless link are used in combination, the hard-wired link can be designated as a primary communication channel, and the wireless link can be designated as a secondary communication channel that is used under condition that the primary communication channel becomes impaired. Alternatively, the wireless link is established as the primary communication channel and the hard-wired link is established as the secondary communication channel.

The antenna array monitor 10 is implemented as a monitoring method for an antenna array constructed according to an alternative embodiment of the present invention. The monitoring method includes establishing the baseline transmission parameters TBL_{X1} between a first antenna A₁ and at least one second antenna A_{X} within the antenna array 1 of the tower 2. The baseline transmission parameters TBL_{X1} are established by coupling a reference stimulus signal SBL₁ at at least one frequency within the series of operating channels to the first antenna A₁ and measuring the reference response signal RBL_{X} to the reference stimulus signal SBL₁ coupled from the at least one second antenna A_{X}. The baseline transmission parameters TBL_{X1} are alternatively established according to mathematical models or empirical data indicating the cross-coupling between the first antenna A₁ and the one or more additional antennas A_{X}, as discussed above.

The monitoring method also includes measuring transmission parameters TM_{X1} between the first antenna A₁ and the at least one second antenna A_{X}. The measured transmission parameters TM_{X1} are established by coupling a measurement stimulus signal SM₁ at the at least one frequency within an inactive channel within the series of operating channels to the first antenna A₁ and measuring a measurement response signal RM_{X} to the measurement stimulus signal SM₁ from the at least one second antenna A_{X}. The baseline transmission parameters TBL_{X1} include a ratio of the reference stimulus signal SBL₁ and the reference response signal RBL_{X}, and the measured transmission parameters TM_{X1} include a ratio of the measurement stimulus signal SM₁ and the measurement response signal RM_{X}. Alternatively, the baseline transmission parameters TBL_{X1} and the measurement transmission parameters TM_{X1} are transmission scattering parameters that are acquired via couplings to designated ones of the feed lines F₁-F_{N} of the antennas A₁-A_{N} within the antenna array 1. The baseline transmission parameters TBL_{X1} and the measured transmission parameters TM_{X1} are between antennas A₁-A_{N} within a common sector or within different sectors of the antenna array 1. The monitoring method also compares the measured transmission parameters TM_{X1} to the baseline transmission parameters TBL_{X1}, and based on the comparison, reports an operating status or condition of the antenna array 1 based on the comparison. The reporting of the operating condition is optionally made to the remote site 28.

While the embodiments of the present invention have been illustrated in detail, it should be apparent that modifications and adaptations to these embodiments may occur to one skilled in the art without departing from the scope of the present invention as set forth in the following claims.

What is claimed is:

1. A monitor for an antenna array, comprising:
a probe, coupled to a first antenna and at least one second antenna within the antenna array of a tower, acquiring transmission parameters between the first antenna and the at least one second antenna in the array, the acquired transmission parameters including baseline transmission parameters between the first antenna and the at least one second antenna and measured transmission parameters between the first antenna and the at least one second antenna;
a communication channel coupling the probe to a remote site, conveying an operating condition of the antenna array based on a comparison of the measured transmission parameters and the baseline transmission parameters.

2. The monitor of claim 1 wherein the probe includes a stimulus/response system establishing the baseline parameters by coupling a reference stimulus signal at at least one frequency within a series of operating channels to a feed line of the first antenna and measuring a reference response signal to the stimulus signal coupled from a corresponding feed line of the at least one second antenna, and establishing the measured transmission parameters by coupling a measurement stimulus signal at the at least one frequency within an inactive channel within the series of operating channels to the feed line of the first antenna and measuring a measurement response signal to the stimulus signal from the corresponding feed line of the at least one second antenna.

3. The monitor of claim 1 wherein the baseline transmission parameters and the measurement transmission parameters are transmission scattering parameters that are acquired by a vector network analyzer coupled to a feed line of the first antenna and coupled to a corresponding feed line of the at least one second antenna.

4. The monitor of claim 2 wherein the baseline transmission parameters and the measurement transmission parameters are transmission scattering parameters that are acquired by a vector network analyzer coupled to the feed line of the first antenna and coupled to the corresponding feed line of the at least one second antenna.

5. The method of claim 1 wherein conveying the operating condition of the antenna array includes indicating when a deviation between the measured transmission parameters and the baseline transmission parameters exceeds a predetermined threshold.

6. The method of claim 1 wherein the communication channel includes at least one of a hard-wired link and a wireless link.

7. A monitoring method for an antenna array, comprising:
establishing baseline transmission parameters between a first antenna and at least one second antenna within an antenna array of a tower using a probe coupled to the first antenna and the at least one second antenna;
measuring transmission parameters between the first antenna and the at least one second antenna with the probe;
comparing the measured transmission parameters to the baseline transmission parameters;
reporting an operating condition of the antenna array to a remote site based on the comparison via a communication channel coupling the probe to the remote site.

8. The monitoring method of claim 7 wherein the probe establishes baseline transmission parameters by coupling a reference stimulus signal at at least one frequency within a series of operating channels to the first antenna and measuring a reference response signal to the stimulus signal coupled from the at least one second antenna, and wherein the probe measures transmission parameters by coupling a measurement stimulus signal at the at least one frequency within an inactive channel within the series of operating channels to the first antenna and measuring a measurement response signal to the stimulus signal from the at least one second antenna.

9. The monitoring method of claim 8 wherein the baseline transmission parameters and the measurement transmission parameters are transmission scattering parameters that are acquired by a vector network analyzer coupled to a feed line of the first antenna and coupled to a corresponding feed line of the at least one second antenna.

10. The monitoring method of claim 7 wherein reporting the operating condition of the antenna array includes indicating when a deviation between the measured transmission parameters and the baseline transmission parameters exceeds a predetermined threshold.

11. A monitoring method for an antenna array, comprising:
establishing baseline transmission parameters between a first antenna and at least one second antenna within the antenna array of a tower;
measuring transmission parameters between the first antenna and the at least one second antenna;
comparing the measured transmission parameters to the baseline transmission parameters;
reporting an operating condition of the antenna array based on the comparison.

12. The monitoring method of claim 11 wherein establishing baseline transmission parameters includes coupling a reference stimulus signal at at least one frequency within each of a series of operating channels to the first antenna and measuring a reference response signal to the stimulus signal coupled from the at least one second antenna, and wherein measuring transmission parameters includes coupling a measurement stimulus signal at the at least one frequency within an inactive channel within the series of operating channels to the first antenna and measuring a measurement response signal to the stimulus signal from the at least one second antenna.

13. The monitoring method of claim 12 wherein the baseline transmission parameters include a ratio of the reference stimulus signal and the reference response signal, and wherein the measured transmission parameters include a ratio of the measurement stimulus signal and the measurement response signal.

14. The monitoring method of claim 12 wherein the baseline transmission parameters and the measurement transmission parameters are transmission scattering parameters.

15. The monitoring method of claim 14 wherein the transmission scattering parameters are acquired by a vector network analyzer coupled to a feed line of the first antenna and coupled to a corresponding feed line of the at least one second antenna.

16. The monitoring method of claim 14 further comprising measuring reflection parameters via couplings to at least one of the feed line to the first antenna and the corresponding feed line of the at least one second antenna.

17. The monitoring method of claim 15 further comprising measuring reflection parameters via couplings to at least one of the feed line to the first antenna and the corresponding feed line of the at least one second antenna.

18. The monitoring method of claim 11 wherein the first antenna and the at least one second antenna are within a common sector of the antenna array.

19. The monitoring method of claim 11 wherein the first antenna and the at least one second antenna are within different sectors of the antenna array.

20. The monitoring method of claim 1 wherein reporting the operating condition of the antenna array includes indicating when a deviation between the measured transmission parameters and the baseline transmission parameters exceeds a predetermined threshold.
